(19) United States
(12) Patent Application Publication
(10) Pub. No.: US 2013/0224322 A1
(43) Pub. Date: Aug. 29, 2013

(54) Method For Cleaning Fine Pattern Surface Of Mold, And Imprinting Device Using Same

(71) Applicants: Noritake Shizawa, Kamisato (JP); Naoaki Yamashita, Kamisato (JP); Masashi Aoki, Kamisato (JP); Tetsuhiro Hatogai, Tokyo (JP)

(72) Inventors: Noritake Shizawa, Kamisato (JP); Naoaki Yamashita, Kamisato (JP); Masashi Aoki, Kamisato (JP); Tetsuhiro Hatogai, Tokyo (JP)

(73) Assignee: Hitachi High-Technologies Corporation, Minato-ku, Tokyo (JP)

(21) Appl. No.: 13/883,844

(22) PCT Filed: Nov. 11, 2011
(86) PCT No.: PCT/JP2011/076111

§ 371 Date: May 7, 2013

(30) Foreign Application Priority Data
Nov. 12, 2010 (JP) 2010-253650

(51) Int. Cl. B29C 59/16; B29C 33/72

(52) U.S. Cl. CPC B29C 59/16; B29C 33/72
USPC 425/155; 134/4

(57) ABSTRACT

A method for removing foreign matters attaching on a surface of a fine pattern of a mold, having the fine pattern being convexo-concave, at least on one surface thereof, thereby cleaning the fine pattern surface of the mold, and an imprinting device applying that method therein, without removing, comprises the following steps of: applying a photo-curable resin on a surface of a body to be transcribed, onto which the mold is suppressed, and thereby forming a photo-curable resin layer; suppressing the mold on the photo-curable resin, which is applied on the surface of the body to be transcribed; separating the photo-curable resin cured from the mold, after curing the photo-curable resin, and whereby taking the foreign matters attaching on the surface of the fine pattern into the photo-curable resin cured to remove them, wherein the photo-curable resin to be formed on the surface of the body to be transcribed is formed with such thickness that it can remove the foreign matters attaching on the fine pattern, and also the mold is suppressed onto the photo-curable resin, which is formed on the surface of the body to be transcribed, under such pressure that it can remove the foreign matters attaching on the fine pattern.

### TECHNICAL FIELD

The present invention relates to an imprinting device for transcribe/forming fine patterns on a surface of a body to be transcribed, and in particular, relates to a method for cleaning a fine pattern surface of a mold, being suitable for such imprinting device, and an imprinting device for enabling the cleaning of the fine pattern surface of the mold, automatically and certainly, with applying that cleaning method therein.

### BACKGROUND OF THE INVENTION

Because of a remarkable increase of performances of various kinds of information equipments, such as, a computer, an amount or volume of the information, which a user must deal with, rises up steadily, and it already reaches to an area of a unit of terabytes from that of gigabytes. Under such circumferences, demands are increasing much more, in particular, for an information recording/reproducing device or a medium, having a recording densitymuch higher than that of before, and further a semiconductor device, such as, a memory, etc.

For increasing the recording density, there is necessity of a machining technology, being finer much more. With the conventional photolithography with applying an exposure process therein, it is possible to conduct fine machining on a large area or surface, at one time; however since having no resolving power less than the wavelength of a light, it is not suitable for a fine structure less than wavelength of the light itself (for example, less than 100 nm). As a machining technology of the fine structure less than the wavelength of lights, there are already known an exposing technology with applying electron beams therein, an exposing technology with applying X-rays therein, and an exposing technology with applying ion beams therein, etc. However, with pattern forming by using an electron beam painting apparatus, differing from that of a batch process applying a light source, such as, an i-beam, an excimer laser, etc., it takes a painting (or exposing) time, the longer, the larger the number of patterns to be drawn by the electron beams. Accordingly, with an increase of the recording density, the time necessary for forming the fine patterns comes to be long, thereby reducing a manufacturing throughput, remarkably. On the other hand, for achieving high-speed of pattern forming by means of the electron beam painting apparatus, development is made on, so-called a block drawing irradiating method, i.e., combining masks having various kinds of forms and irradiating electron beams thereon in one lot; however, an electron beam printing apparatus applying the block drawing irradiating method therein comes to be large in the sizes thereof, and it also necessitates a mechanism for controlling the position of the masks, at high accuracy much more, as a result thereof, it brings about drawbacks, such as, increasing a medium manufacturing cost, etc.

As a machining technology for the fine structure less than the wavelength of lights is proposed a method through a printing technology, in the place of the conventional exposing technology mentioned above. For example, in the following Patent Document 1 is described an invention relating to “nano imprint lithography (NIL) technology. The nano imprint lithography is a technology for transcribing the fine structure patterns of a mold onto a resist layer of a substrate to be transcribed, while pressurizing the mold, on which predetermined fine structure patterns are formed in advance, with using a machining technology for the fine structure less than the wavelength of lights, such as, an electron beam exposing technology, etc., onto the substrate to be transcribed, on which the resist is applied. Since, there is no necessity of an especially expensive exposing apparatus, but if there is the mold, it is possible to manufacture duplicates in mass production by means of an apparatus at a level of a normal printer, then the throughput can be increased, dramatically, comparing to such electron beam exposing technology, etc., as mentioned above, and the manufacturing cost thereof is also reduced, greatly.

With the nano imprint lithography technology, as is described in the following Patent Document 1, in particular, when applying a thermoplastic resin (for example, PMMA) as the resist, the transcription is conducted by pressurizing while rising the temperature thereof to that in the vicinity of a glass transition temperature (Tg) of that material or higher than that. This method is called “a thermal transfer method”. This thermal transfer method has an advantage that a general-purpose resin can be applied, widely, if it is the thermoplastic resin. On the contrary to this, in case where a photosensitive resin is applied as the resist, the transcription is conducted by a curable resin, which will be cured if being exposed in the lights, such as, ultraviolet rays, etc. This method is called “a photo transcription method”.

With the nano imprint machining technology of the photo-transcription, although it is necessary to apply a specific photo-curable resin; however, comparing to the thermal transfer method, there is an advantage that dimensional errors can be diminished of a finished product, due thermal expansion of a thermal transfer plate and/or a material to be printed. Also, on that apparatus, there are following advantages, i.e., that no accessory equipment is needed, such as, an equipment of heating mechanism, an apparatus for heating, temperature controlling, cooling, etc., and further that no consideration should be taken when designing, for countermeasures against thermal deformation, such as, heat insulation, etc., as a nano imprinting device as a whole.

### PRIOR ART DOCUMENTS

### Patent Documents

[Patent Document 1] U.S. Pat. No. 5,772,905.

### BRIEF SUMMARY OF THE INVENTION

### Problems(s) to be Dissolved by the Invention

FIGS. 7A to 7D are schematic views for showing the steps of a fine structure transcribing method in accordance with the nano imprinting technology of the photo transcription method of the conventional technology. In the step shown in FIG. 7A is prepared a body to be transcribed, i.e., a substrate 100, on an upper surface of which a resist 120 is applied, and a stamper 33, on a side of which to abut on the resist 120 are formed fine patterns 34, is brought to stand facing to the body to be transcribed, i.e., the substrate 100. In the step shown in FIG. 7B, the stamper 33 is pressurized on a resist applying surface of the body 100 to be transcribed. In the step shown in FIG. 7C, ultraviolet (UV) rays or lights are irradiated from an upper surface of the stamper 33, so as to cure the resist 120. Next, in the step shown in FIG. 7D, the stamper 33 is exfoliated from the body 100 to be transcribed. After a minute, a pattern layer 130 of the resist on the front surface of the substrate 100, i.e., the body to be transcribed. The pattern layer 130 is an inverse image of the fine patterns 34 of the stamper 33.

However, there are cases where foreign matters attach on a convexo-concave pattern of the fine pattern 34 mentioned above, and it is true still more, in particular, when continuing such reverse operation as mentioned above. When conducting the transcribing operation while keeping the foreign matters attached on the convexo-concave pattern of the fine pattern 34, a defect (s) is/are generated on the pattern layer 130 of the substrate 100, i.e., the body to be transcribed, and this results into a reason of a defective product. For that reason, when the foreign matters attach on the convexo-concave pattern of the fine pattern 34, it is necessary to exchange the mold to a new one, or to take out that mold from a supporting tool thereof, so as to remove the foreign matters attaching on the upper surface thereof, and to attach the mold to the supporting tool, again.

Then, conventionally, as a method for removing the foreign matters on the convexo-concave pattern of the fine pattern is performed cleaning by means of a liquid, exfoliation by means of an adhesive tape or the like, for example. However, with those conventional methods, it is possible to remove the foreign matters attaching on a part, but excepting the pattern concave portion therefrom, easily; however, it is impossible or very difficult to remove the fine foreign matters, in particular, creeping into an inside of the pattern concave portion, with certainty. Also, in particular, in case of cleaning by means of the liquid, it is also necessary to remove the liquid, which enters into inside of the pattern concave portion, by drying it, etc., and this results into a cause of reason of bringing the cleaning operation of the mold to be complex much more. Anyways, the conventional cleaning operation takes time and labor, and this also results into a cause of reason of reducing the throughput through a transcribing operation, remarkably.

The present invention is accomplished by taking the problems of the conventional technology mentioned above into the consideration thereof, and an object thereof is to provide a method for enabling a cleaning of the foreign matters attaching on the fine pattern surface of the mold, without removing the mold from the supporting tool thereof, and further an imprinting device applying the same therein.

### Means for Dissolving the Problem(s)

For accomplishing the object mentioned above, according to the present invention, first of all, there is provided a method for removing foreign matters attaching on a surface of a fine pattern of a mold, having the fine pattern being convexo-concave, at least on one surface thereof, thereby cleaning the fine pattern surface of said mold, comprising the following steps of: applying a photo-curable resin on a surface of a body to be transcribed, onto which said mold is suppressed, and thereby forming a photo-curable resin layer; suppressing said mold on said photo-curable resin, which is applied on the surface of said body to be transcribed; separating said photo-curable resin cured from said mold, after curing said photo-curable resin, and whereby taking the foreign matters attaching on the surface of said fine pattern into said photo-curable resin cured to remove them, wherein the photo-curable resin to be formed on the surface of said body to be transcribed is formed with such thickness that it can remove the foreign matters attaching on the fine pattern, and also said mold is suppressed onto said photo-curable resin, which is formed on the surface of said body to be transcribed, under such pressure that it can remove the foreign matters attaching on the fine pattern.

Also, according to the present invention, within the method for cleaning the fine pattern surface of said mold, as mentioned in the above, it is preferable that the photo-curable resin to be formed on the surface of said body to be transcribed is formed with thickness within a range from 10 μms to 500 μms, and further that viscosity of said photo-curable resin to be formed on the surface of said body to be transcribed is within a range from 500 cPs to 6,000 μms. Or, it is preferable that the pressure onto said photo-curable resin of said body to be transcribed is within a range from 1 kPa to 10 kPas.

In addition to the above, according to the present invention, also for accomplishing such object as mentioned above, there is provided an imprinting device, comprises: a substrate supplying portion, which is configured to store substrates, being a body to be transcribed, in an inside thereof, and supply said substrates; a photo-curable resin film forming portion, which is configured to apply a photo-curable resin in form of a film on a surface of said substrate, which is supplied from said substrate supplying portion; a fine pattern forming portion, which is configured to form a fine pattern on the surface of said substrate, by forming and curing the fine pattern under suppression of a mold onto said photo-curable resin, which is applied in the film-like form within said photo-curable resin film forming portion; and a controller portion, which is configured to control operations in said substrate supplying portion, said photo-curable resin film forming portion and said fine pattern forming portion, wherein said fine pattern forming portion further comprises: said mold, a means for suppressing/exfoliating said mold with respect to a surface of said substrate, on which the photo-curable resin film is formed, and a means for irradiating lights on said photo-curable resin, which is applied on the surface of said substrate, for hardening thereof, and said controller portion executes the method for cleaning the fine pattern surface of said mold, as described in the claim 1, at a predetermined timing, in an operation for forming the fine pattern on the surface of said substrate by said imprinting device.

Also, according to the present invention, within such imprinting device, as mentioned in the above, it is preferable that said controller portion has a means for changing a suppressing force of said suppressing/exfoliating means, or that said controller portion further has a means for changing thickness of said photo-curable resin, which is to be applied in said photo-curable resin film forming portion. Or, it is preferable that said controller portion further has a means for changing viscosity of said photo-curable resin, which is to be applied in said photo-curable resin film forming portion.

Further, according to the present invention, within such imprinting device, as mentioned in the above, it is preferable that said controller portion executes said method for cleaning the fine pattern surface of said mold, at timing depending on a number of times of operations for forming the fine pattern on the surface of said substrate, which are conducted by said imprinting device, or that said controller portion executes said method for cleaning the fine pattern surface of said mold, at timing depending on time of execution of operations for forming the fine pattern on the surface of said substrate, which are conducted by said imprinting device.

Also, further, according to the present invention, within such imprinting device, as mentioned in the above, it is preferable that said fine pattern forming portion further comprises: a means for detecting adhesion of foreign matters on the surface of said substrate, and said controller portion executes said method for cleaning the fine pattern surface of said mold, at timing of a detection output from said foreign matter detecting means, or that said substrate supplying portion stores a substrate for use of mold cleaning, as well as, said substrate, in the inside thereof, and supply said substrate and said substrate for use of mold cleaning, selectively, and said controller portion executes said method for cleaning the fine pattern surface of said mold, at timing when said substrate for use of mold cleaning is supplied.

### Effect(s) of the Invention

In accordance with the present invention mentioned above, there is obtain an effect that it is possible to provide a method for enabling a cleaning of the foreign matters attaching on the fine pattern surface of the mold, without removing the mold from the supporting tool thereof, and further an imprinting device applying the same therein.

### BRIEF DESCRIPTION OF THE SEVERAL VIEWS OF THE DRAWING

FIG. 1 is an outline structural view for showing the entire configuration of an imprinting device, according to an embodiment of the present invention;

FIG. 2 is a side view for showing the detailed structure of a transcribing (imprinting) portion in the imprinting device mentioned above;

FIG. 3 is a block diagram for showing the detailed structure of a controller portion in the imprinting device mentioned above;

FIGS. 4A to 4C are explanatory views for explaining a mold cleaning method, according to the present invention, to be applied or embodied in the imprinting device mentioned above;

FIGS. 5A and 5B are views for showing pictures of mold surfaces obtained through an optical microscope, for exemplifying an effect of the mold cleaning method, according to the present invention;

FIG. 6 is a flow chart for showing an example of operations for deciding necessity/un-necessity of the mold cleaning method in the imprinting device mentioned above; and

FIGS. 7A to 7D are view for showing an example of steps of the transcribing method of fine structure, according to the conventional technology.

### EMBODIMENT(S) FOR CARRYING OUT THE INVENTION

Hereinafter, explanation will be given on an imprinting device for transcribing/forming fine patterns on a surface of a body to be transcribed, according to an embodiment of the present invention, and further a method for cleaning a fine pattern surface of a mold for that purpose, by referring to the drawings attached herewith.

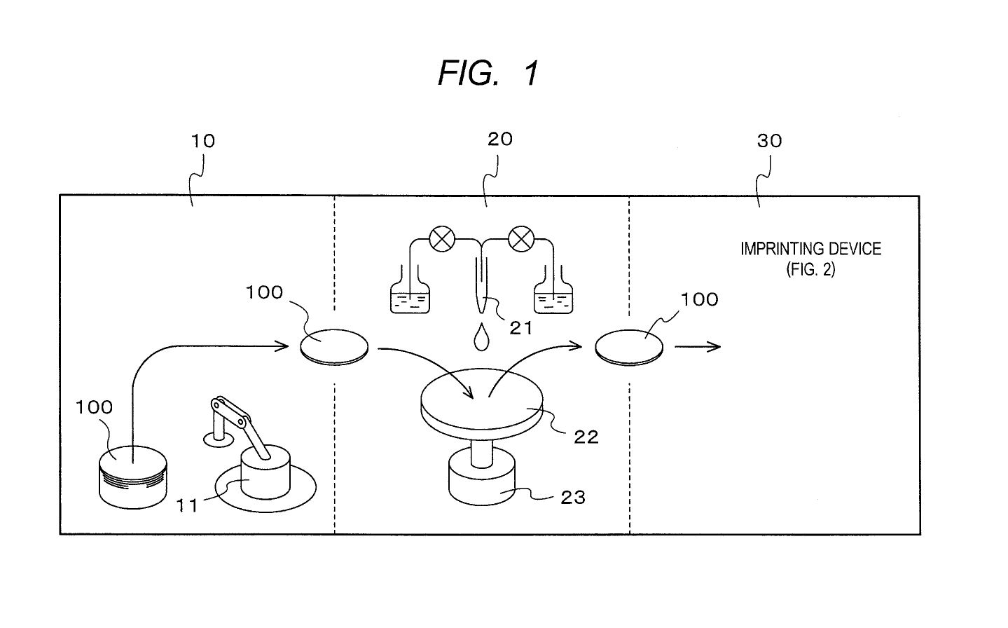

FIG. 1 is an outline structural view for showing the entire configuration of an imprinting device of a photo transcription method, as an example of devices, according to an embodiment of the present invention, and in this figure, a reference numeral 10 depicts a carry-in portion for carrying a substrate 100, being a body to be transcribed, into an apparatus, which will be mentioned hereinafter. However, in the present example, a disc-like one is shown as the substrate 100, being the body to be transcribed, as an example thereof, and in an inside of the carry-in portion 10 are stored a large number of pieces of the substrates 100, and also is provided a common robot arm 11, etc., having a sucking mechanism through vacuum at a tip thereof, for example; thereby carrying/supplying the substrate, one by one, sequentially.

A reference numeral 20 in the figure depicts a photo-curable resin film forming portion, i.e., for applying/forming a photo-curable resin in the form of a film, which will be mentioned hereinafter. However, this photo-curable resin film forming portion 20 comprises the followings, in an inside thereof, in the present example; a constant amount liquid discharger (i.e., a dispenser) 21 for dripping a photo-curable resin, which will be mentioned later, on a surface of the substrate 100 carried in, and so-called a rotating table 22, for rotating that substrate 100 mounted on an upper surface thereof at a predetermined rotating speed through an electric motor 23, etc.

Further, a reference numeral 30 in the figure depicts so-called a transcribing (i.e., imprinting) portion, for forming the fine pattern on the surface of that substrate, by introducing the substrate 100, on the surface of which the film of the photo-curable resin is formed in the photo-curable resin film forming portion 20 mentioned above, pressurizing a stamper (i.e., a mold, o the surface of which a fine pattern is formed) on the surface thereof, and also irradiating ultraviolet (UV) lights, for example, on the photo-curable resin so as to cure it, and thereafter taking out that mold from the substrate 100.

However, since the substrate carry-in portion 10 and the photo-curable resin film forming portion 20, which are mentioned above, can be constructed, for each, by an apparatus, which is already known and put into a practical use, generally, for example, it is possible to adopt a common coating device for the latter, therefore the detailed explanation thereof will be omitted herein. Also, it is apparent for the person skilled in the art that the photo-curable resin film forming portion 20 may be a one for forming a film-like photo-curable resin on the surface of the substrate 100 through a spin-coating, a roll-coating, a blade-coating or an ink-jet, etc., or may be other one having other structures thereof.

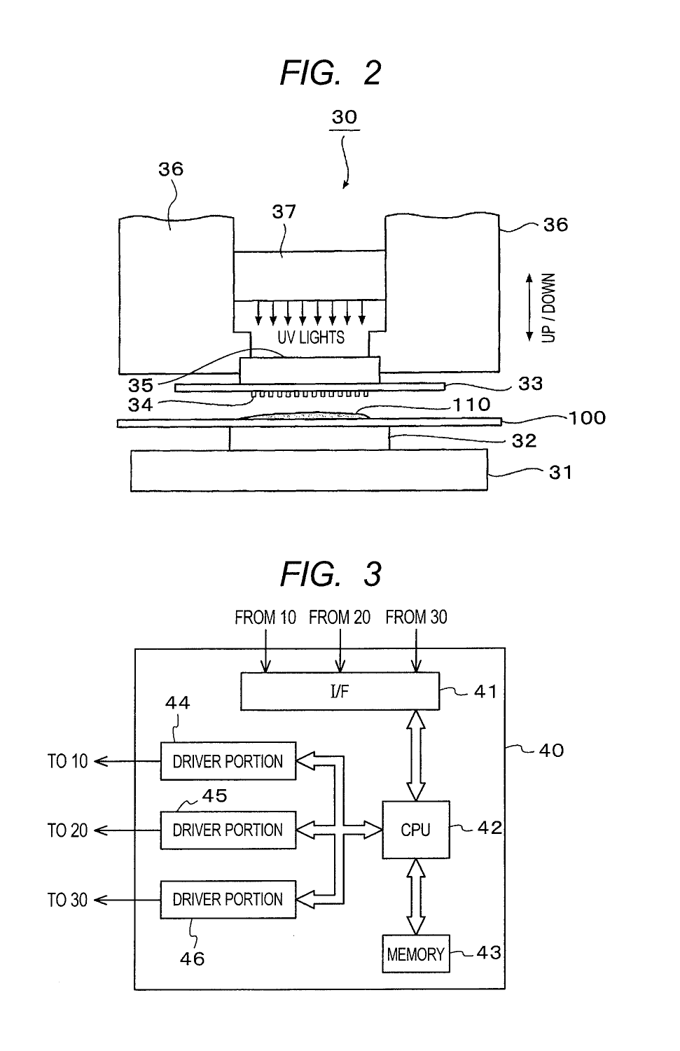

Next, FIG. 2 shows the detailed structures of the transcribing (i.e., the imprinting) portion 30. In the figure, within the transcribing portion 30 is provided a pedestal 32 on an upper surface of a base 31, and on an upper surface of that pedestal 32 is mounted the substrate 100, on the surface of which a photo-curable resin 110 is applied in the form of a film. A translucent mold (i.e., the stamper) 33, being made of glass or the like, for example, is disposed in such a manner that it stands opposite to the substrate 100, on which the photo-curable resin 110 is applied. On a lower surface of this mold 33 is formed a convexo-concave fine structure (i.e., pattern) 34. This mold 33 is supported on a member (i.e., a translucent supporting portion) 35, also being made of a translucent material, and further this holding member 35 by a pair of up/down arms 36. Also, above the translucent member 35 is provided a UV light source 37 (for example, being made of a light-emitting diode (LED)), and that UV light source is also held by the up/down arms 36 mentioned above, in the similar manner thereof.

Further, in FIG. 3 is shown the controller portion 40 controlling and/or driving the operations of portions building up the imprinting device mentioned above. In the present embodiment, it comprises, for example, an interface (I/F) portion 41 between an external portion, for inputting a signal from each of the portions mentioned above, a calculation processor portion (CPU) 42 for executing necessary controls, as well as, observing the operation of each portion through a predetermined calculation process, a memory 43, being a memory device for storing data necessary for various kinds of calculation processing programs and calculation processes in that calculation processor portion, and a driver portion for outputting a control signal to each portion upon basis of a calculation result by that calculation processor portion, i.e., a carry-in operation driver portion 44, a resin-film forming operation driver portion 45 and a transcribing operation driver portion 46.

Thus, the controller portion 40 mentioned above controls/drives the operation in each of portions of the imprinting device in a mold cleaning operation, the details of which will be mentioned hereinafter. In more details, the carry-in operation driver portion 44 controls/drives suction of the substrate by the robot arm 11 and movement thereof, within the carry-in operation driver portion 44, the resin-film forming operation driver portion 45 controls/drives the operations of the constant amount liquid discharger (i.e., the dispenser) 21 within the photo-curable resin film forming portion 20, appropriately, for example, selection of a liquid to be dripped and/or an amount thereof, and further the rotating speed of the rotating table 22, etc. And, the transcribing operation driver portion 46 controls/drives each of the portions, building up the transcribing (imprinting) portion 30, respectively, so that it carries out necessary actions in a cleaning operation, which will be mentioned hereinafter, as well as, the actions necessary for a general nano-printing operation.

Following to the above, explanation will begiven herein after on the operations when the imprinting device, the structure of which is explained in the above, conducts the mold cleaning operation according to the present invention.

First of all, the up/down arms 36 are lowered down so that the convexo-concave fine pattern 34 of the translucent mold 33 contacts on the photo-curable resin 110, which is applied on the upper surface of the substrate 100, and under this condition, UV lights from the UV light source 37 are irradiated on the photo-curable resin 110 through the translucent member 35, and thereby curing or hardening that photo-curable resin 110. After completion of this UV hardening operation, the up/down arms 36 are raisedup, and thereby exfoliating the mold 33 from the substrate 100. In this instance, since the foreign matters lying within the convexo-concave fine pattern 34 of the translucent mold 33 are taken into the photo-curable resin layer 16, to be exfoliated from, then the mold 33 can turns back into the condition where no foreign matter lies within the convexo-concave fine pattern 34 thereof, i.e., the condition of being clean.

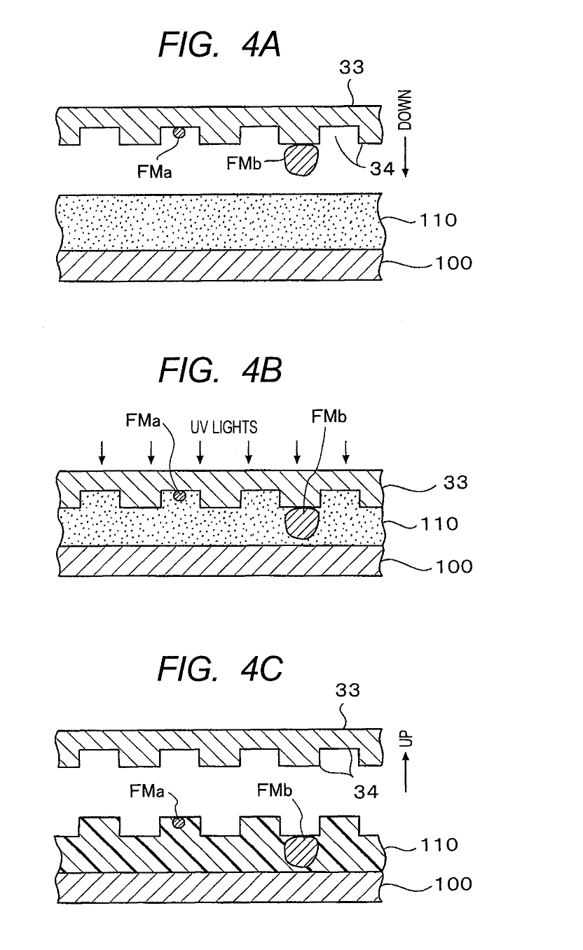

FIGS. 4A to 4C are partial enlarged cross-section views for showing an embodiment for carrying out a method for cleaning the mold fine pattern surface, according to the present invention. In FIG. 4A, a fine foreign matter “FMa” creeping into the concave portion of the convexo-concave fine pattern 34, which is formed on the lower surface of the translucent mold 33, while on the other hand, on the convex portion thereof is attached other foreign matter “FMb”, having such a largeness or size, that it cannot enters into the concave portion. On the upper surface of the substrate 100 is applied the photo-curable resin 110, with thickness exceeding that of such foreign matter as mentioned above, in particular, the size of the foreign matter “FMb”.

Next, in FIG. 4B, the mold 33 is brought to touch on the photo-curable resin 110, and the mold 33 is suppressed onto the photo-curable resin layer 16. In this instance, with abutting or suppressing of the mold 33 onto the photo-curable resin 110, both the fine foreign matter “FMa” lying within the concave portion of the fine pattern, and also the large foreign matter “FMb” lying within the convex portion thereof enter into the photo-curable resin 110. Under this condition, the UV lights are irradiated from the upper surface of the mold 33 for a predetermined time-period, and thereby curing the photo-curable resin 110. With doing this, the photo-curable resin layer 16 is hardened by the irradiation of the UV lights, and the various kinds of foreign matters “FMa” and “FMb”, differing from in the size thereof, are taken into an inside of that photo-curable resin layer hardened.

Thereafter, as is shown in FIG. 4C, the mold 33 is raised up, to separate or exfoliate from the substrate 100. With doing this, the foreign matters “FMa” and “FMb” are removed from the fine pattern 34, and then the mold cleaning operation is completed.

However, in the explanation given in the above, although the explanation is given that the body to be transcribed/formed the fine pattern thereon, i.e., the substrate 100 is utilized, in the mold cleaning operation mentioned above; however, according to the present invention, it is also possible to apply, in the place of such the substrate as mentioned above, a substrate 100′ for use of mold cleaning, to be used exclusively, in the mold cleaning method. This substrate 100′ for use of mold cleaning can be manufactured by, for example, silicon, plastic (for example, acrylic resin, etc.), glass, metal (for example, aluminum), etc. This substrate 100′ for use of mold cleaning, although being formed to be same to the substrate 100, in the outer configuration, should not be restricted to that, in particular, in the thickness thereof. In other words, for this, it is enough to have a mechanical strength, being necessary and sufficient to execute the cleaning operation thereon. However, in case of using a general substrate 100 therein, that substrate 100 cannot be used as a product thereafter; but there is no necessity of always using the substrate 100′ for cleaning the mold.

Also, as a material of the photo-curable resin 110 to be used in the mold cleaning method according to the present invention may be used a resin of an unsaturated polyester group, an accrylate group or an acryl group, etc., for example. Such photo-curable resins are available on the market, in general, produces by various chemical companies, and further it is also possible to include a photopolymerization starting agent in those resins.

In the method of applying the photo-curable resin 110 on the substrate 100 or the substrate 100′ for use of mold cleaning, to be applied in the mold cleaning method, according to the present invention, it is common to drip a resin liquid at around a central portion thereof, from the constant amount liquid discharger (i.e., the dispenser) 21, and thereafter, to spread that resin liquid from the central portion of the substrate towards to the periphery thereof, through spinning or suppressing the mold 33 on the surface of the substrate. However, other than those methods as mentioned above, it is also possible to apply a low-speed spin coating, a roll coating, or a blade coating, etc. Also, the thickness of the resin layer, which will be formed through spreading thereof directing from the central portion of the substrate 100 or 100′ towards to the periphery thereof, is preferably within a range from 10 μms to 500 μms. This is because if the thickness of the resin layer, being suppressed and spread, is less than 10 μms, then the large foreign matter exceeding 10 μms in the size thereof cannot be taken into the resin layer to be harden. On the other hand, if the thickness of the resin layer, being suppressed and spread, exceeds 500 μms, then the resin itself flows out; then, it is difficult, not only to maintain the thickness to be uniform, but also takes times too much for the UV curing of the photo-curable resin layer 110; thereby lowering an operating efficiency. In a general optical nano printing operation, the resist layer, to be formed on the upper surface of the substrate 100, is applied through a high-speed spin coating method, and the thickness thereof is from 50 nm to 100 nm, approximately; on the contrary to this, the mold cleaning method, according to the present invention, is characterized that the photo-curable resin layer 110 is formed as thick as 100 times or more thereof.

Also, a viscosity of the photo-curable resin to be applied in the mold cleaning method, according to the present invention lies within a range from 500 cPs up to 6,000 cPs, preferably. This is because, if the viscosity is less than 500 cPs, then fluidity thereof is too high; i.e., for the photo-curable resin layer 110, it is difficult, not only to stay on the surface of the substrate 100 or the substrate 100′ for use of mold cleaning, but it also comes to be thin in the thickness thereof with elapsing of time, and therefore it is difficult to maintain the resin layer at a desired thickness thereof. On the other hand, if the viscosity exceeds 6,000 cPs, then the fluidity thereof is too low; there are possibilities that it takes a long time for spreading the photo-curable resin layer 110 by suppressing the mold on the surface of the substrate, and that it cannot enter into the concave portion of the fine pattern of the mold.

Thus, in the mold cleaning method, according to the present invention, a suppression force when suppressing the mold 33 onto the substrate 100 or the substrate 100′ for use of mold cleaning, lies within a region from 1 kPa to 10 kPas, preferably. This suppression force is preferably to be changeable depending on the viscosity of the photo-curable resin layer 110 to be applied in the mold cleaning method. When the material is low in the viscosity, a low suppressing force is applied; but when it is high in the viscosity, a high suppressing force is applied. This suppressing force is, not only necessary for creeping the photo-curable resin layer 110 into the fine pattern, but also important for spreading the photo-curable resin layer 110. In more details, if the suppressing force is less than 1 kPa, there can be considered a possibility that the photo-curable resin layer 110 cannot enter into the fine pattern, fully, but also that the spreading of the photo-curable resin layer 110 comes to high too much, and thereby causing damage on the fine pattern of the mold.

Further, in the mold cleaning method according to the present invention, although the explanation is given that the mold 33 is made of the translucent material, such as, a transparent resin or the glass, etc.; however, the present invention should not be limited only to this, and it may be that, upon which the UV lights for use of curing can be irradiated from a side direction (s) thereof, for example.

### Embodiment 1

Explanation will be given on an example of carrying out the mold cleaning method according to the present invention, hereinafter, by referring to such imprinting device as mentioned above. However, in this embodiment 1, on the surface of the translucent glass substrate 33 is formed the fine pattern 34, i.e., forming the convex portion having width of 60 nm and the concave portion having width of 60 nm at depth of 50 nm, and on the surface of the convex portion of this fine pattern 34 is attached a foreign matter, in advance.

On the upper surface of a silicon-made substrate 100′ for use of mold cleaning, having a diameter (φ) of 4 inches and thickness of 0.5 mm, is dripped the photo-curable resin of the unsaturated polyester group, having the viscosity of 4,500 cP, from the constant amount liquid discharger (i.e., the dispenser) 21. Suppression of the mold 33, having such foreign matter as mentioned thereon, onto the layer 110 of the photo-curable resin of the unsaturated polyester group, under the pressure of 10 kPa, spreads the photo-curable resin of the unsaturated polyester group, which is formed on the surface of the substrate 100, and thereby forms a resin layer having the thickness of 50 μm. Still under this condition, the UV lights from the UV light source are irradiated for two (2) seconds, thereby curing the photo-curable resin of the unsaturated polyester group. Thereafter, the mold is separated or exfoliated from the substrate 100′ for use of mold cleaning.

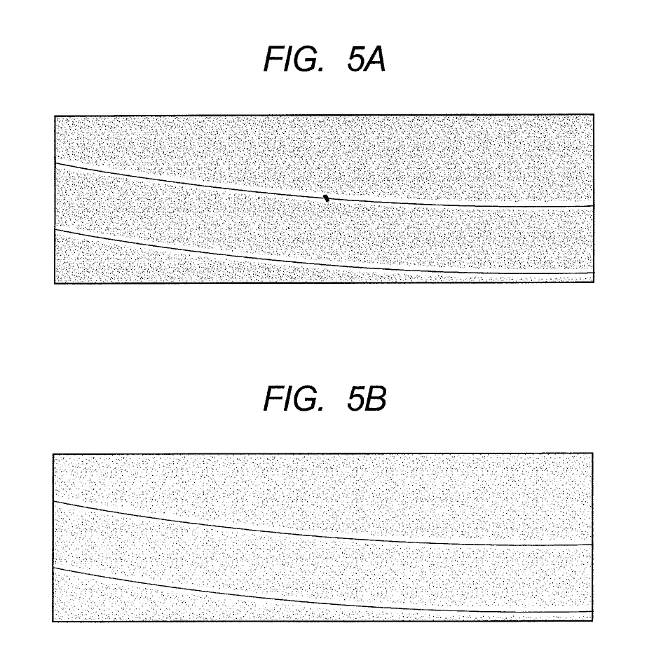

For exemplifying an effect of cleaning, an inspection is made on the surface of the mold 33 by using an electron microscope. A result of this is shown in FIGS. 5A and 5B. FIG. 5A is a photo of the surface of the mold, before cleaning, obtained through the electron microscope, and FIG. 5B is a photo of the mold surface, after cleaning, through the electron microscope, respectively. As can be seen in FIG. 5A, the foreign matter, which is attached in advance, can be found or acknowledged, on the surface of the mold, but in FIG. 5B, it can be seen that the foreign matter is removed from, with certainty, on the surface of the mold, which is cleaned by the method according to the present invention.

### Embodiment 2

With using the same apparatus as mentioned above, the mold cleaning method according to the present invention is carried out. On the surface of the translucent glass substrate 33 is formed the fine pattern 34, i.e., forming the convex portion having width of 60 nm and the concave portion having width of 60 nm at depth of 50 nm, and on the surface of the convex portion is attached the foreign matter, in advance, similarly, as mentioned above.

On the upper surface of a silicon-made substrate 100′ for use of mold cleaning, having a diameter (φ) of 4 inches and thickness of 0.5 mm, is dripped the photo-curable resin of the unsaturated polyester group, having the viscosity of 4,500 cP, from the constant amount liquid discharger (i.e., the dispenser) 21. Suppression of the mold 33, having such foreign matter as mentioned thereon, onto the layer 110 of photo-curable resin of the unsaturated polyester group, under the pressure of 3 kPa, spreads the photo-curable resin of the unsaturated polyester group, on the surface of the substrate 100, and thereby forms a resin layer having the thickness of 300 μm. Still under this condition, the UV lights from the UV light source are irradiated for two (2) seconds, thereby curing the photo-curable resin of the unsaturated polyester group. Thereafter, the mold is separated or exfoliated from the substrate 100′ for use of mold cleaning.

For the purpose of exemplifying an effect of this cleaning, an inspection is made on the surface of the mold 33 by using an electron microscope. A result of that is same to that shown in FIG. 5B.

Furthermore, it can be considered that determination may be made, if the mold cleaning method should be executed or not, within such imprinting device as mentioned above, for example, in an inspection process, while inspecting if there are defects or not, on the surface of the pattern layer of the body to be transcribed, which is obtained, in a process of the imprinting operation with respect to a normal body to be transcribed (for example, inspecting the surface of the substrate by photographing it through a CCD camera not shown in the figure), and made upon basis of the inspection result thereof. Thus, if there are defects in the pattern layer of the body to be inspected, then a cause of reason thereof can be assumed that the convexo-concave pattern of the mold is damaged, or that the foreign matter lies attaching on that convexo-concave pattern. And, in case where the cause of reason of generating the defects lies in the damage of the convexo-concave pattern of the mold, it is necessary to replace the mold itself; however if the cause of reason of generating the defects lies in the foreign matter attaching on the convexo-concave pattern, there can be applied the cleaning method according to the present invention.

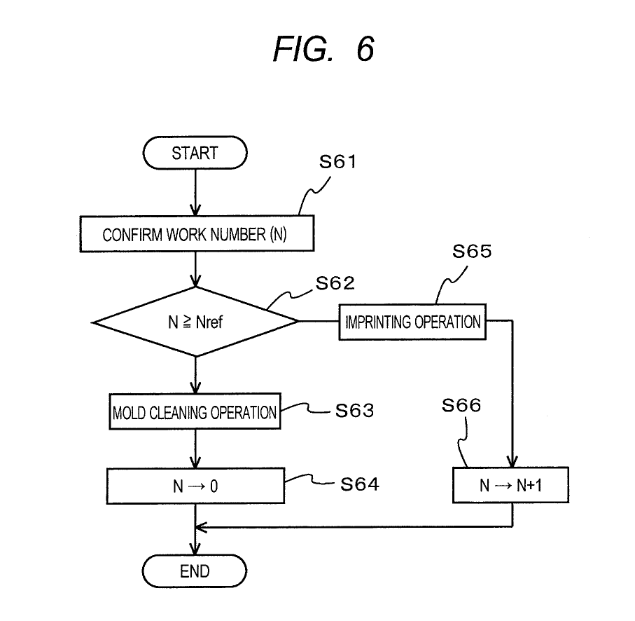

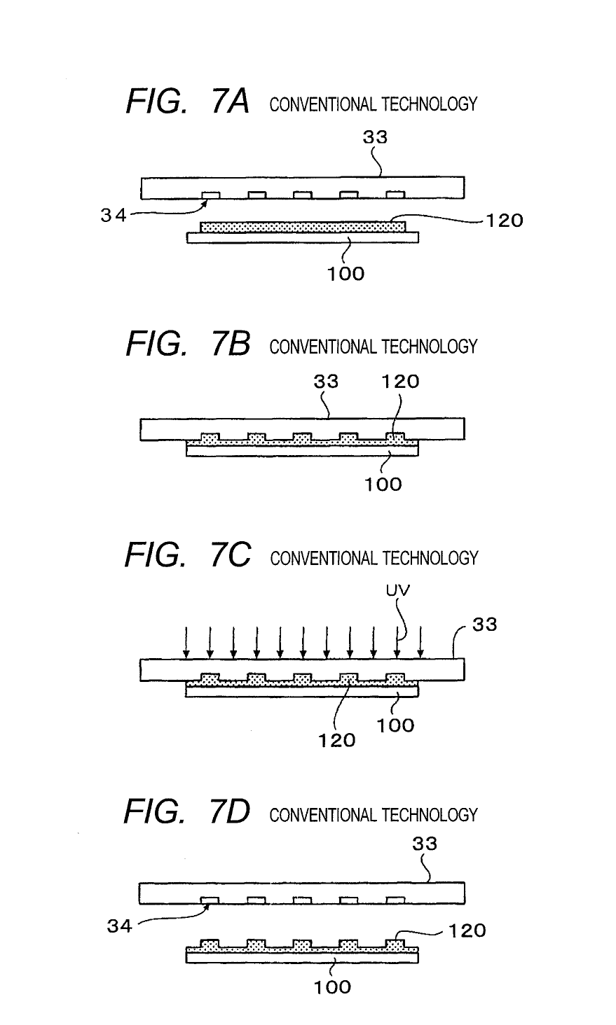

Or, in the process of the normal imprinting process may be executed such the mold cleaning method as mentioned above, at a certain constant rate. In more details thereof, as an example thereof, such the mold cleaning method as mentioned above maybe executed, as is shown in FIG. 6, every time when the normal imprinting operation is executed by a predetermined number of times (for example, 1,000 times). Thus, in FIG. 6, when starting the imprinting operation, confirmation (i.e., storing within the memory 43 shown in FIG. 3 mentioned above) is made on a number of times (N) of that operation (step S61), and determination is made on if that number reaches to a predetermined number “Nref” (in the present example, Nref=1,000) or not (in step S62). As a result thereof, if the number of times (N) reaches to the predetermined number “Nref” (see “YES” in the figure), the mold cleaning operation mentioned above is executed (in step S63), and thereafter, by resetting the number of times (N) to “0”, a series of processes is ended. On the other hand, if the number of times (N) does not reach to the predetermined number “Nref” (see “NO” in the figure), the normal imprinting operation is conducted (in step S65), and thereafter, by incrementing (N→N+1) the number of times (N) (in step S65), the series of processes is ended. However, such operations as mentioned above maybe executed by the calculation processor portion (CPU) 42 building up the controller portion 30 shown in FIG. 3 mentioned above. Also, in the above-mentioned, necessity/un-necessity of the mold cleaning operation may be determined, depending on the time-period of a fine pattern forming operation, in the place of the number of times (N).

Furthermore, in the place of that mentioned above, such mold cleaning operation as mentioned above may be executed, for example, upon an instruction made by a worker through a switch, etc., not shown in the figure, and in that case, within the photo-curable resin film forming portion 20 mentioned above, the photo-curable resin, in the place of the normal resist material, is dripped on the upper surface of the substrate 100 or the substrate 100′ for use of mold cleaning, by means of the constant amount liquid discharger (i.e., the dispenser) 21, thereby forming the photo-curable resin layer 110, and then in the transcribing portion 30, it may be determined if the normal imprinting operation should be conducted, or the mold cleaning operation mentioned above (i.e., a cleaning mode) after detecting the thickness of the layer, which is formed on the substrate carried into.

Although the detailed explanation was given on the mold cleaning method according to the present invention and also the imprinting device applying the same therein; however, the present invention should not be restricted only to the preferable embodiments, which are disclosed in the above, and it maybe apparent for the skilled in the art that various variations and changes thereof would be possible within a spirit of the present invention. For example, the mold cleaning method and the imprinting device according to the present invention are applicable, for example, in an imprinting device for imprinting on both surfaces, other than the imprinting device for one surface mentioned above.

### EXPLANATION OF MARES

10 . . . substrate carry-in portion, 20 . . . photo-curable resin film forming portion, 21 . . . constant amount liquid discharger (i.e., dispenser), 22 . . . rotating table, 30 . . . transcribing (imprinting) portion, 33 . . . mold (stamper), 34 convexo-concave fine structure (pattern), 37 . . . UV lights, 36 . . . up/down arm, 100 . . . substrate, 100′. . . substrate for use of cleaning, 110 . . . photo-curable resin (layer).

What is claimed is:

1. A method for removing foreign matters attaching on a surface of a fine pattern of a mold, having said fine pattern being convexo-concave, at least on one surface thereof, thereby cleaning the fine pattern surface of said mold, comprising the following steps of:
applying a photo-curable resin on a surface of a body to be transcribed, onto which said mold is suppressed, and thereby forming a photo-curable resin layer;
suppressing said mold on said photo-curable resin, which is applied on the surface of said body to be transcribed;
separating said photo-curable resin cured from said mold, after curing said photo-curable resin, and whereby taking the foreign matters attaching on the surface of said fine pattern into said photo-curable resin cured to remove them, wherein
the photo-curable resin to be formed on the surface of said body to be transcribed is formed with such thickness that it can remove the foreign matters attaching on the fine pattern, and also
said mold is suppressed onto said photo-curable resin, which is formed on the surface of said body to be transcribed, under such pressure that it can remove the foreign matters attaching on the fine pattern.

2. The method for cleaning the fine pattern surface of said mold, as described in the claim 1, wherein the photo-curable resin to be formed on the surface of said body to be transcribed is formed with thickness within a range from 10 μms to 500 μms.

3. The method for cleaning the fine pattern surface of said mold, as described in the claim 2, wherein viscosity of said photo-curable resin to be formed on the surface of said body to be transcribed is within a range from 500 cPs to 6,000 μms.

4. The method for cleaning the fine pattern surface of said mold, as described in the claim 1, wherein the pressure onto said photo-curable resin of said body to be transcribed is within a range from 1 kPa to 10 kPas.

5. An imprinting device, comprises:
a substrate supplying portion, which is configured to store substrates, being a body to be transcribed, in an inside thereof, and supply said substrates;
a photo-curable resin film forming portion, which is configured to apply a photo-curable resin in form of a film on a surface of said substrate, which is supplied from said substrate supplying portion;
a fine pattern forming portion, which is configured to form a fine pattern on the surface of said substrate, by forming and curing the fine pattern under suppression of a mold onto said photo-curable resin, which is applied in the film-like form within said photo-curable resin film forming portion; and
a controller portion, which is configured to control operations in said substrate supplying portion, said photo-curable resin film forming portion and said fine pattern forming portion, wherein
said fine pattern forming portion further comprises:
said mold, a means for suppressing/exfoliating said mold with respect to a surface of said substrate, on which the photo-curable resin film is formed, and a means for irradiating lights on said photo-curable resin, which is applied on the surface of said substrate, for hardening thereof, and
said controller portion executes the method for cleaning the fine pattern surface of said mold, as described in the claim 1, at a predetermined timing, in an operation for forming the fine pattern on the surface of said substrate by said imprinting device.

6. The imprinting device, as described in the claim 5, wherein said controller portion has a means for changing a suppressing force of said suppressing/exfoliating means.

7. The imprinting device, as described in the claim 5, wherein said controller portion further has a means for changing thickness of said photo-curable resin, which is to be applied in said photo-curable resin film forming portion.

8. The imprinting device, as described in the claim 5, wherein said controller portion further has a means for changing viscosity of said photo-curable resin, which is to be applied in said photo-curable resin film forming portion.

9. The imprinting device, as described in the claim 5, wherein said controller portion executes said method for cleaning the fine pattern surface of said mold, at timing depending on a number of times of operations for forming the fine pattern on the surface of said substrate, which are conducted by said imprinting device.

10. The imprinting device, as described in the claim 5, wherein said controller portion executes said method for cleaning the fine pattern surface of said mold, at timing depending on time of execution of operations for forming the fine pattern on the surface of said substrate, which are conducted by said imprinting device.

11. The imprinting device, as described in the claim 5, wherein said fine pattern forming portion further comprises:
a means for detecting adhesion of foreign matters on the surface of said substrate, and
said controller portion executes said method for cleaning the fine pattern surface of said mold, at timing of a detection output from said foreign matter detecting means.

12. The imprinting device, as described in the claim 5, wherein said substrate supplying portion stores a substrate for use of mold cleaning, as well as, said substrate, in the inside thereof, and supply said substrate and said substrate for use of mold cleaning, selectively, and
said controller portion executes said method for cleaning the fine pattern surface of said mold, at timing when said substrate for use of mold cleaning is supplied.
